(19) United States
(12) Patent Application Publication
(10) Pub. No.: US 2018/0273312 A1
(43) Pub. Date: Sep. 27, 2018

(54) SHEET STORAGE DEVICE AND SHEET HANDLING APPARATUS

(71) Applicant: FUJITSU FRONTECH LIMITED, lnagi (JP)

(72) Inventors: Yasushi GOTOH, lnagi (JP); Hiroshi YANAGIDA, lnagi (JP); Ryo FUJIWARA, lnagi (JP); Koichi HOSOYAMA, lnagi (JP)

(73) Assignee: FUJITSU FRONTECH LIMITED, lnagi (JP)

(21) Appl. No.: 15/991,514

(22) Filed: May 29, 2018

Related U.S. Application Data
(63) Continuation of application No. PCT/JP2015/085577, filed on Dec. 18, 2015.

(51) Int. Cl. B65H 1/06; B65H 1/12; G07D 11/00

(52) U.S. Cl. CPC B65H 1/06; G07D 11/0084; B65H 1/12

(57) ABSTRACT

A sheet storage device includes: an accommodation unit that accommodates a sheet in a manner stacking on a certain surface; a sheet sliding unit that is positioned on a first end side of a sheet accommodated in the accommodation unit and sequentially slides a sheet from a sheet positioned in a lowermost layer; and a supporting unit that is positioned on a second end side opposite to the first end side of a sheet accommodated in the accommodation unit and supports an area around the second end of the sheet in a manner separating from the certain surface by being pressed by a weight of the sheet and an own weight.

### CROSS-REFERENCE TO RELATED APPLICATION

This application is a continuation application of International Application PCT/JP2015/085577, filed on Dec. 18, 2015 and designating the U.S., the entire contents of which are incorporated herein by reference.

### FIELD

The present invention relates to a sheet storage device and a sheet handling apparatus.

### BACKGROUND

Typical bill handling apparatuses such as an automatic teller machine (ATM) includes a bill storage device for storing bills. An exemplary bill storage device accommodates bills of different sizes and different denominations together and sequentially feeds the bills in the bill handling apparatus using a pick roller for picking up a bill and a sheet feeding roller for feeding the picked up bill (see Patent Document 1 and Patent Document 2, for example).
Patent Document 1: Japanese Patent Application Laid-open No. 2002-167101
Patent Document 2: Japanese Patent Application Laid-open No. 09-077288

With the above-described conventional techniques, however, jamming (a paper jam) of slid out bills is problematically caused by the following factors. For example, when picking up a relatively small size bill, the bill is not caught by the pick roller. In another case, if a relatively large size bill is placed on a relatively small size bill and the small size bill is picked up by the pick roller, the small size bill is slid with the large size bill overlapped thereon, and the difference in size causes the large size bill to reach the sheet feeding roller earlier. Because of these factors, a sheet handling apparatus including a sheet storage device in the above-described conventional techniques problematically causes jamming of sheets including bills.

### SUMMARY

According to an aspect of the embodiments, a sheet storage device includes: an accommodation unit that accommodates a sheet in a manner stacking on a certain surface; a sheet sliding unit that is positioned on a first end side of a sheet accommodated in the accommodation unit and sequentially slides a sheet from a sheet positioned in a lowermost layer; and a supporting unit that is positioned on a second end side opposite to the first end side of a sheet accommodated in the accommodation unit and supports an area around the second end of the sheet in a manner separating from the certain surface by being pressed by a weight of the sheet and an own weight.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a perspective view of the appearance of a bill handling apparatus according to an embodiment;

FIG. 2 is a schematic view of a general configuration of the bill handling apparatus including a bill storage device according to the embodiment;

FIG. 3 is a perspective view of the bill storage device according to the embodiment;

FIG. 4A is a flat view of the bill storage device according to the embodiment when viewed from A direction of FIG. 3;

FIG. 4B is a side view of the bill storage device according to the embodiment when viewed from B direction of FIG. 3;

FIG. 4C is a side view of the bill storage device according to the embodiment when viewed from C direction of FIG. 3;

FIG. 4D is a front view of the bill storage device according to the embodiment when viewed from D direction of FIG. 3;

FIG. 4E is a back view of the bill storage device according to the embodiment when viewed from E direction of FIG. 3;

FIG. 5A is a perspective view of the appearance (with a cover unit opened) of the bill storage device according to the embodiment;

FIG. 5B is a perspective view of the appearance (with the cover unit opened) of the bill storage device according to the embodiment;

FIG. 6A is a flat view of the bill storage device (with the cover unit opened) according to the embodiment when viewed from A direction of FIG. 5A;

FIG. 6B-1 is a side view of the bill storage device (with the cover unit opened) according to the embodiment when viewed from B direction of FIG. 5A;

FIG. 6B-2 is a sectional view of the bill storage device according to the embodiment along I-I line of FIG. 6A;

FIG. 6C is a side view of the bill storage device according to the embodiment when viewed from C direction of FIG. 5A;

FIG. 6D is a front view of the bill storage device according to the embodiment when viewed from D direction of FIG. 5A;

FIG. 7 is a perspective view of the bill storage device (with the cover unit opened and with an upstanding portion of a bill accommodation unit inclined) according to the embodiment;

FIG. 8A is a flat view of the bill storage device (with the cover unit opened and with the upstanding portion of the bill accommodation unit inclined) according to the embodiment when viewed from A direction of FIG. 7;

FIG. 8B is a side view of the bill storage device (with the cover unit opened and with the upstanding portion of the bill accommodation unit inclined) according to the embodiment when viewed from C direction of FIG. 7;

FIG. 8C is a front view of the bill storage device (with the cover unit opened and with the upstanding portion of the bill accommodation unit inclined) according to the embodiment when viewed from D direction of FIG. 7;

FIG. 9 is a schematic view of a general configuration of the bill storage device according to the embodiment;

FIG. 10A illustrates a schematic configuration relating to bill feeding in the bill storage device according to the embodiment;

FIG. 10B illustrates a schematic configuration relating to bill feeding in the bill storage device according to the embodiment;

FIG. 10C illustrates a schematic configuration relating to bill feeding in the bill storage device according to the embodiment;

FIG. 10D illustrates a schematic configuration relating to bill feeding in the bill storage device according to the embodiment;

FIG. 11A is a schematic view of a first form of a bill rear-end lifting unit of the bill storage device according to the embodiment;

FIG. 11B is a schematic view of a second form of the bill rear-end lifting unit of the bill storage device according to the embodiment;

FIG. 11C is a schematic view of a third form of the bill rear-end lifting unit of the bill storage device according to the embodiment;

FIG. 11D is a schematic view of a fourth form of the bill rear-end lifting unit of the bill storage device according to the embodiment;

FIG. 12A illustrates a schematic configuration relating to bill feeding in a bill storage device according to a conventional technique;

FIG. 12B illustrates a schematic configuration relating to bill feeding in the bill storage device according to the conventional technique;

FIG. 12C illustrates a schematic configuration relating to bill feeding in the bill storage device according to the conventional technique;

FIG. 12D illustrates a schematic configuration relating to bill feeding in the bill storage device according to the conventional technique;

FIG. 13A illustrates a schematic configuration relating to bill setting in the bill storage device according to the embodiment; and

FIG. 13B illustrates a schematic configuration relating to bill setting in the bill storage device according to the embodiment.

### DESCRIPTION OF EMBODIMENTS

Embodiments of a sheet storage device and a sheet handling apparatus according to the present invention will now be described with reference to the accompanying drawings. The embodiments will be described using an automatic teller machine (ATM) as an example of a sheet handling apparatus and a bill cassette of the ATM as an example of a sheet storage device; however, the disclosed techniques are not limited thereto. The disclosed techniques are widely applicable to sheet handling apparatuses that mix sheets of different sizes and accommodate the sheets in an accommodatable cassette, have the cassette installed in the sheet handling apparatus, and feed the sheets from the cassette.

Forms in the embodiments can be combined as appropriate within the scope with the consistency maintained. Like numerals indicate like components and like processing, and components and processing already described will not be repeatedly described. In the embodiments, references to positions such as upper, lower, left, right, front, and rear indicate relative positions in the drawings.

### EMBODIMENTS

Appearance of Bill Handling Apparatus

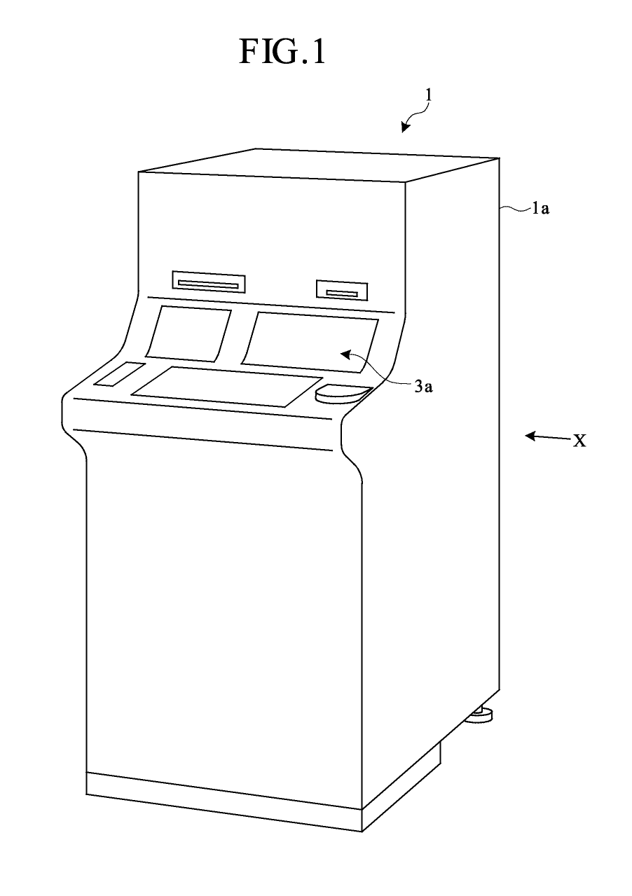

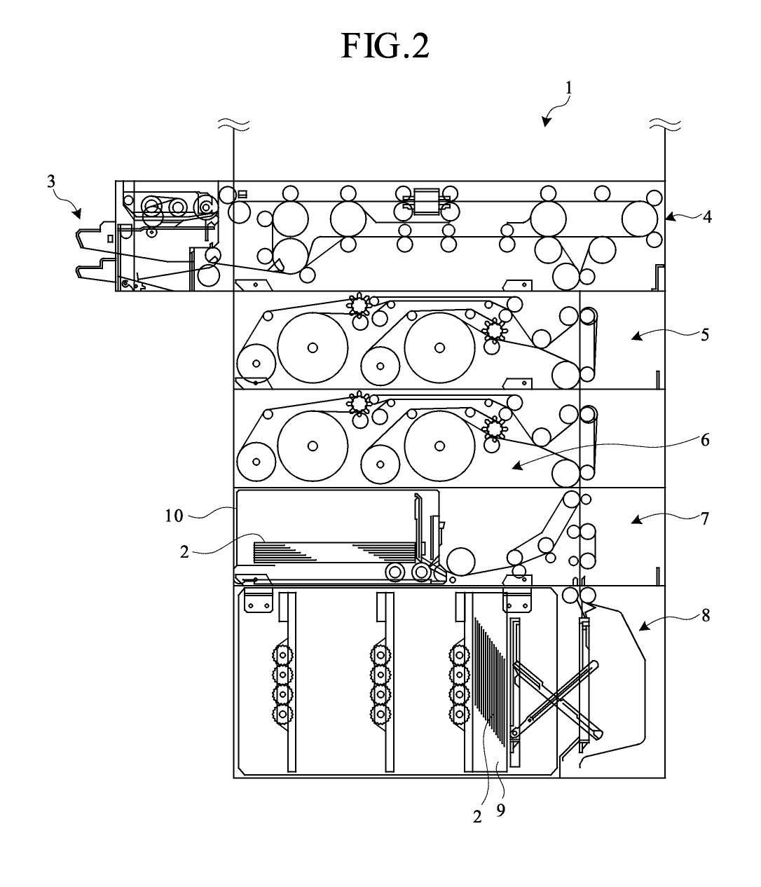

FIG. 1 is a perspective view of the appearance of a bill handling apparatus according to an embodiment. A bill handling apparatus 1 according to the embodiment includes a display and an operation panel, a passbook entry slot, a cash card entry slot, a bill slot 3a, a coin slot, a biometric information reader for biometric authentication, and others on a side facing the operator of a housing 1a. The bill handling apparatus 1 further includes a door for having the inside of the bill handling apparatus 1 open so as to install a bill storage device 10 (see FIG. 2) as a bill cassette and others in the bill handling apparatus 1.

Configuration of Bill Handling Apparatus

FIG. 2 is a schematic view of a general configuration of a bill handling apparatus including a bill storage device according to the embodiment. FIG. 2 is a schematic sectional view of the bill handling apparatus 1 of FIG. 1 when viewed from X direction of FIG. 1. As illustrated in FIG. 2, the bill handling apparatus 1 according to the embodiment includes, inside the housing, a deposit and withdrawal unit 3 for depositing and withdrawing a bill 2, a validation unit 4 for validating the bill 2 deposited in the deposit and withdrawal unit 3, and a temporary retaining unit 5 for temporarily retaining the bill 2 conveyed from the validation unit 4. The deposit and withdrawal unit 3 is positioned close to the bill slot 3a (see FIG. 1). The bill handling apparatus 1 further includes a circulation unit 6 for circulating the bill 2 retained in the temporary retaining unit 5, a withdrawal unit 7 where the bill storage device 10 accommodating therein the bills 2 for withdrawal is installed, and a storage unit 8 for storing the bill 2 in a storage room 9.

The bill storage device 10 is a cassette (or a cartridge) that accommodates the bills 2 of different sizes and different denominations in a manner stacking on the plane surface and supplies the accommodated bills 2 to the bill handling apparatus 1. The difference in size means, for example, a difference in length. The bill storage device 10 is retained in the withdrawal unit 7 with the bills 2 accommodated therein. The withdrawal unit 7 is an example of the retaining unit. The bill storage device 10 sequentially feeds the accommodated bills 2 and supplies the bills 2, for example, to a recycle cassette (not illustrated) included in the circulation unit 6. In the embodiment, the bill storage device 10 is an example of the sheet storage device. Moreover, in the embodiment, the bill 2 is used as an example of a sheet; however, the embodiment is not limited to a bill. In the embodiment, a bill supply cassette is given as an example of the bill storage device 10; however, another kind of cassette accommodating sheets may be applicable.

Bill Storage Device

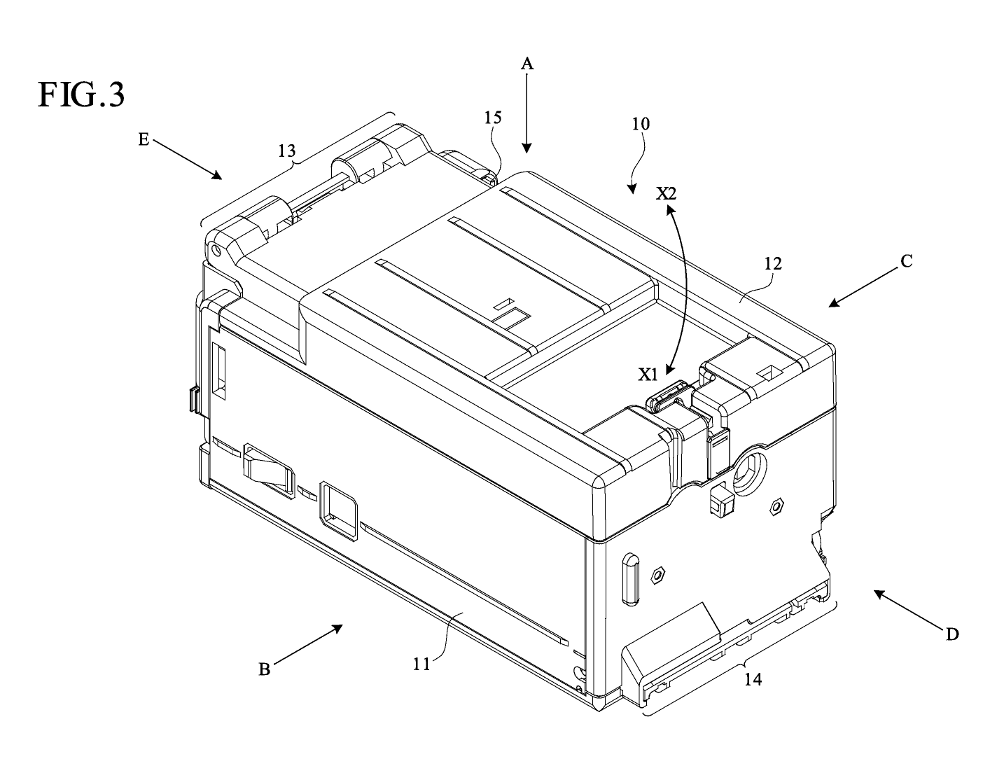

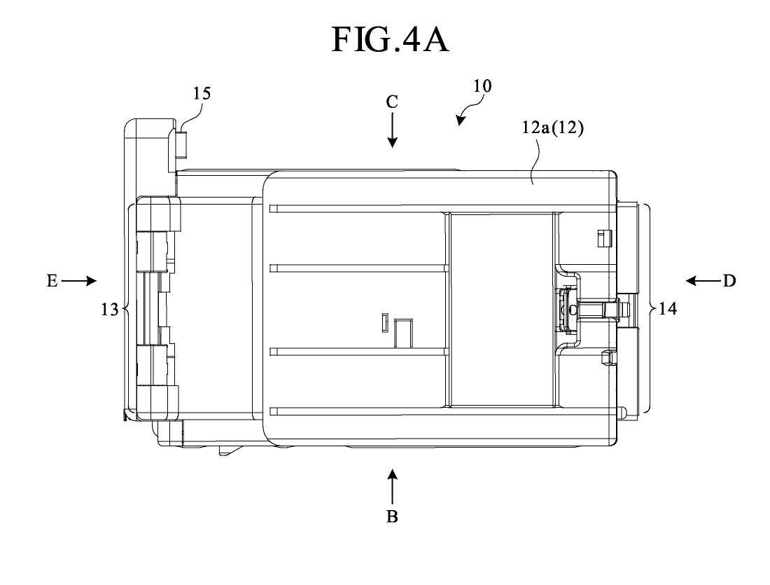

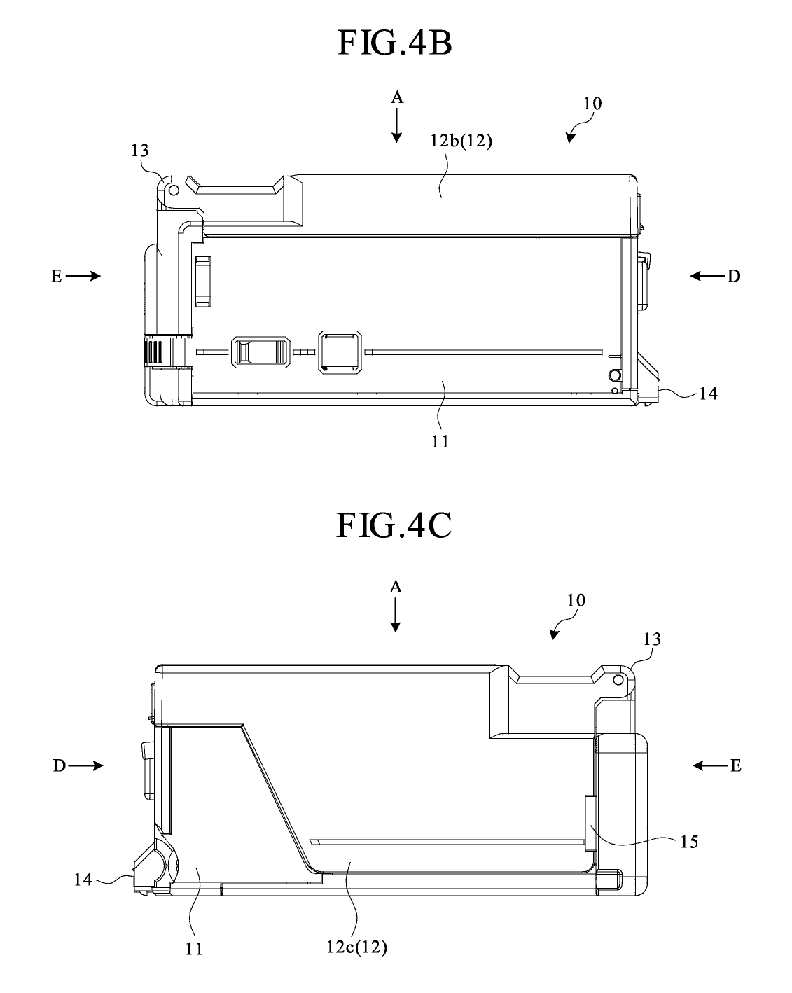

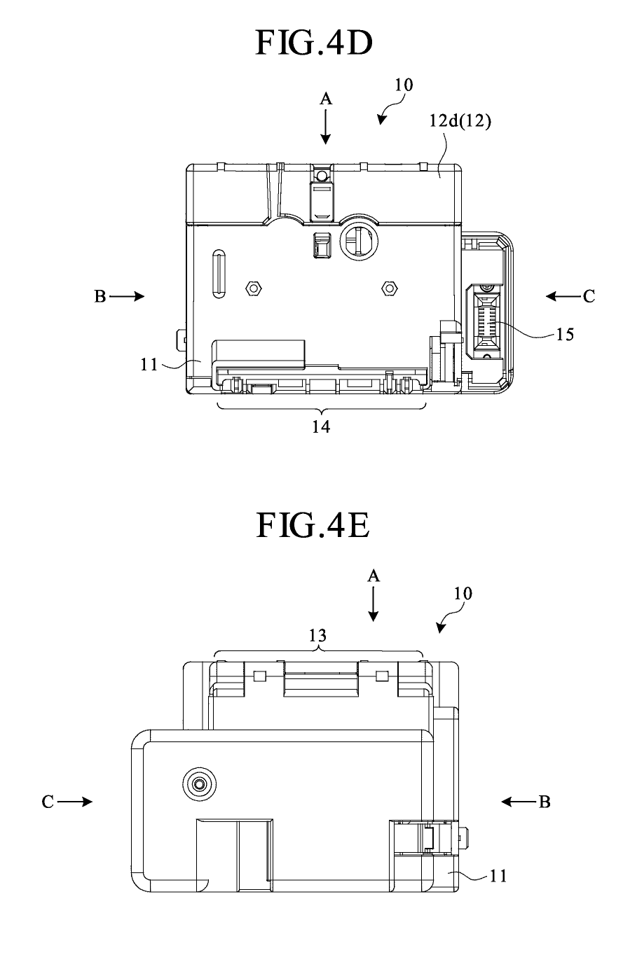

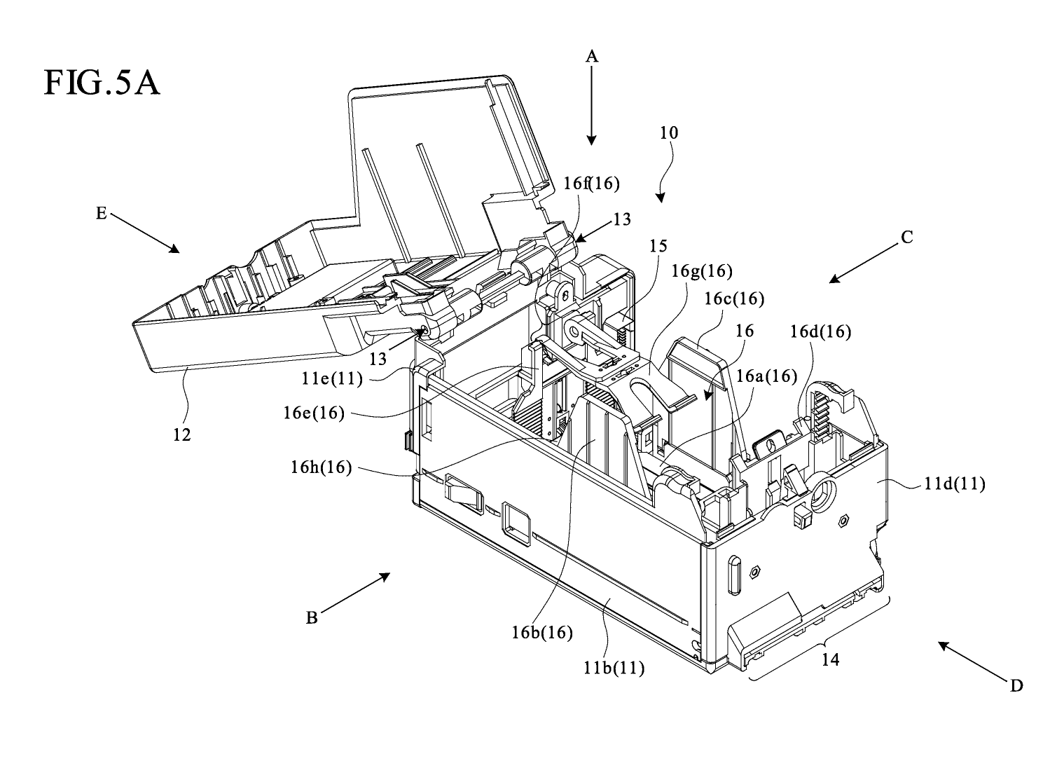

FIG. 3 is a perspective view of the bill storage device according to the embodiment. FIG. 4A is a flat view of the bill storage device according to the embodiment when viewed from A direction of FIG. 3. FIG. 4B is a side view of the bill storage device according to the embodiment when viewed from B direction of FIG. 3. FIG. 4C is a side view of the bill storage device according to the embodiment when viewed from C direction of FIG. 3. FIG. 4D is a front view of the bill storage device according to the embodiment when viewed from D direction of FIG. 3. FIG. 4E is a back view of the bill storage device according to the embodiment when viewed from E direction of FIG. 3. The directions of A to E are shared between the subsequent drawings. The bill storage device 10 is installed in the withdrawal unit 7 of the bill handling apparatus 1 from E direction.

As illustrated in FIG. 3 and FIGS. 4A to 4E, the bill storage device 10 is in a substantially rectangular parallelepiped shape and has a body unit 11, a cover unit 12, a hinge unit 13, a bill ejection port 14, and a connection unit 15. As described later, the cover unit 12 is connected with the body unit 11 through the hinge unit 13 and is half rotated with respect to the body unit 11 using the shaft of the hinge unit 13 as a rotation axis. The cover unit 12 closes the opening portion of the body unit 11 by half rotating in X1 direction of FIG. 3 using the shaft of the hinge unit 13 as a rotation axis and having the area from a portion with the hinge unit 13 to a portion farthest from the hinge unit 13 mate with the body unit 11 and forms a substantially rectangular parallelepiped shape along with the body unit 11. The cover unit 12 is opened and accordingly has the opening portion of the body unit 11 exposed by half rotating in X2 direction of FIG. 3 using the shaft of the hinge unit 13 as a rotation axis and having the area from the portion with the hinge unit 13 to the portion farthest from the hinge unit 13 separated from the body unit 11.

As illustrated in FIG. 4A, the cover unit 12 has a top board surface 12a on the side of A direction. As illustrated in FIG. 4B, the cover unit 12 has a side board surface 12b on the side of B direction. As illustrated in FIG. 4C, the cover unit 12 has a side board surface 12c on the side of C direction. As illustrated in FIG. 4D, the cover unit 12 has a side board surface 12d on the side of D direction. In other words, the cover unit 12 is a cover body constituted of the top board surface 12a, the side board surfaces 12b to 12d, and the hinge unit 13.

On the cover unit 12, the side board surface 12c has a larger area than those of the side board surfaces 12b and 12d. As seen from comparison between FIG. 4B and FIG. 4C, the side board surface 12c covers most areas of the side surface, substantially from the upper side to the lower side, of the bill storage device 10 compared to the side board surface 12b. As will be described later, this is because the body unit 11 of the bill storage device 10 has a larger notch on the side of C direction than that on the side of B direction and needs to be more widely covered by the cover unit 12 on the side of C direction.

The bill ejection port 14 is an ejection port for ejecting bills set inside the bill storage device 10. As described later in detail, the bill storage device 10 has, from the side closer to the bill ejection port 14, a separation roller and a pick roller inside thereof. The bill storage device 10 has the front end area of a bill in the longitudinal direction contact the pick roller and slides out the bill by means of rotation of the pick roller using friction between the bill and the pick roller. The bill storage device 10 further has the bill slid by the pick roller contact the separation roller and has the bill ejected outside the bill storage device 10 from the bill ejection port 14 by means of rotation of the separation roller using friction between the bill and the separation roller.

The connection unit 15 is connected with a certain terminal provided to the withdrawal unit 7 of the bill handling apparatus 1 and forwards, for example, supply power and control signals from a control unit (not illustrated) of the bill handling apparatus 1 to the bill storage device 10 and response signals from the bill storage device 10 to the control unit of the bill handling apparatus 1.

Bill Storage Device with the Cover Unit Opened

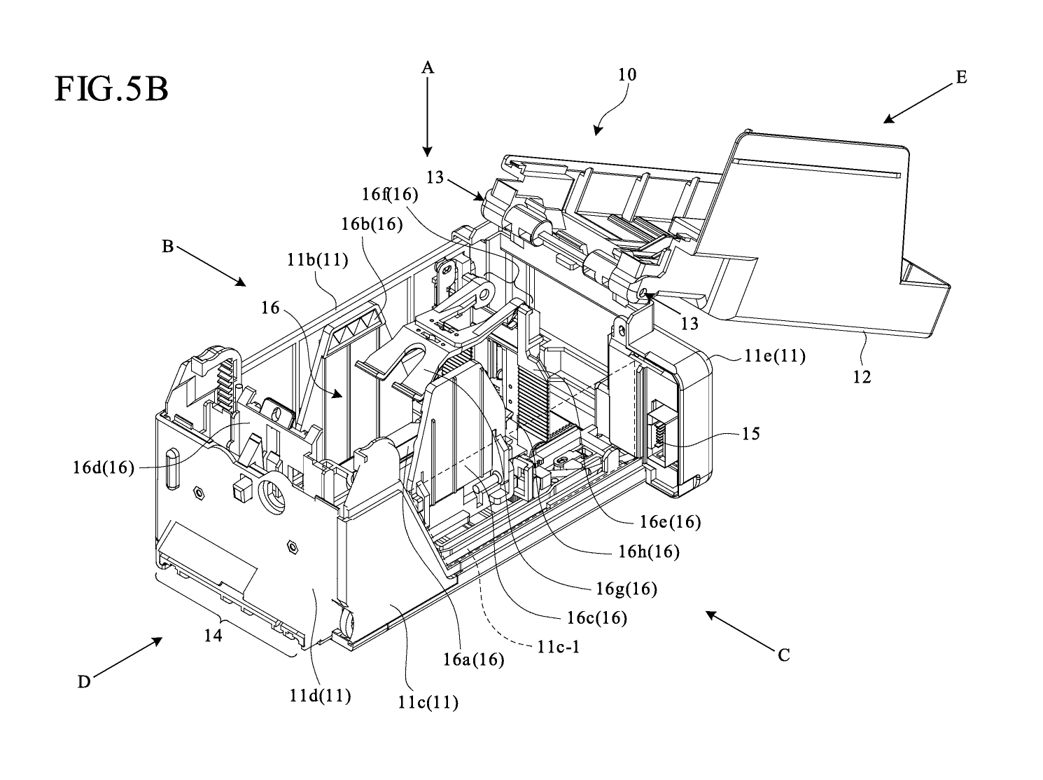

FIG. 5A and FIG. 5B are perspective views of the appearance (with the cover unit opened) of the bill storage device according to the embodiment. FIG. 5A illustrates the bill storage device 10 with the cover unit 12 opened when viewed from B direction. FIG. 5B illustrates the bill storage device 10 with the cover unit 12 opened when viewed from C direction.

As illustrated in FIG. 5A and FIG. 5B, the body unit 11 of the bill storage device 10 includes, as surfaces upstanding from the bottom surface, an upstanding surface 11b on the side of B direction, an upstanding surface 11c on the side of C direction, an upstanding surface 11d on the side of D direction, and an upstanding surface 11e on the side of E direction. As a difference from the upstanding surface 11b, the upstanding surface 11c has a notch extending almost to the bottom surface of the body unit 11.

The bill storage device 10 includes a bill accommodation unit 16 in the space surrounded by the bottom surface and the upstanding surfaces 11b to 11e of the body unit 11. The bill accommodation unit 16 is positioned on the bottom surface of the body unit 11 and includes a bottom surface portion 16a having bills or a bundle of bills accommodated in the bill storage device 10 placed thereon and upstanding portions 16b to 16e upstanding from the respective four sides of the bottom surface portion 16a. The upstanding portion 16b is provided in a manner upstanding on the side of B direction of the bottom surface portion 16a. The upstanding portion 16c is provided in a manner upstanding on the side of C direction of the bottom surface portion 16a. The upstanding portion 16d is provided in a manner upstanding on the side of D direction of the bottom surface portion 16a. The upstanding portion 16e is provided in a manner upstanding on the side of E direction of the bottom surface portion 16a.

As described later in detail, the upstanding portion 16c of the bill accommodation unit 16 can be inclined outward of the bill storage device 10 from an upstanding base provided in a manner upstanding on the bottom surface portion 16a of the bill accommodation unit 16 across a notch portion 11c-1 of the upstanding surface 11c. This configuration allows the bills to be set in the later-described bill accommodation space of the bill accommodation unit 16 laterally from C direction across the notch portion 11c-1 of the upstanding surface 11c.

A bill rear-end pressing unit 16g is half rotatably provided to the upper end of the upstanding portion 16e through a hinge unit 16f using the shaft of the hinge unit 16f as a rotation axis. As described later in detail, the upstanding portion 16e is provided with the bill rear-end lifting unit 16h having the front end extending toward the inside surrounded by the upstanding portions 16b to 16e and having the level on the upstanding portion 16e varying depending on the weight of the bills.

The bill storage device 10 can set bills in the bill accommodation space surrounded by the upstanding portions 16b to 16e of the bill accommodation unit 16. The bill storage device 10 presses the bills set in the bill accommodation space inward of the bill accommodation space with the upstanding portions 16b to 16e, for example, by adjusting positions of the upstanding portions 16b to 16e in the horizontal direction or by using elastic force and holds the bills with the four sides of the bills aligned. For example, with the upstanding portions 16b and 16c pressing the bills, the bills are aligned in the lateral (the width) direction. With the upstanding portions 16d and 16e pressing the bills, the bills are aligned in the longitudinal direction.

The bill storage device 10 further presses the bills set in the bill accommodation space downward from above with the front end of the bill rear-end pressing unit 16g, for example, by adjusting the position of the bill rear-end pressing unit 16g in the vertical direction or by using elastic force.

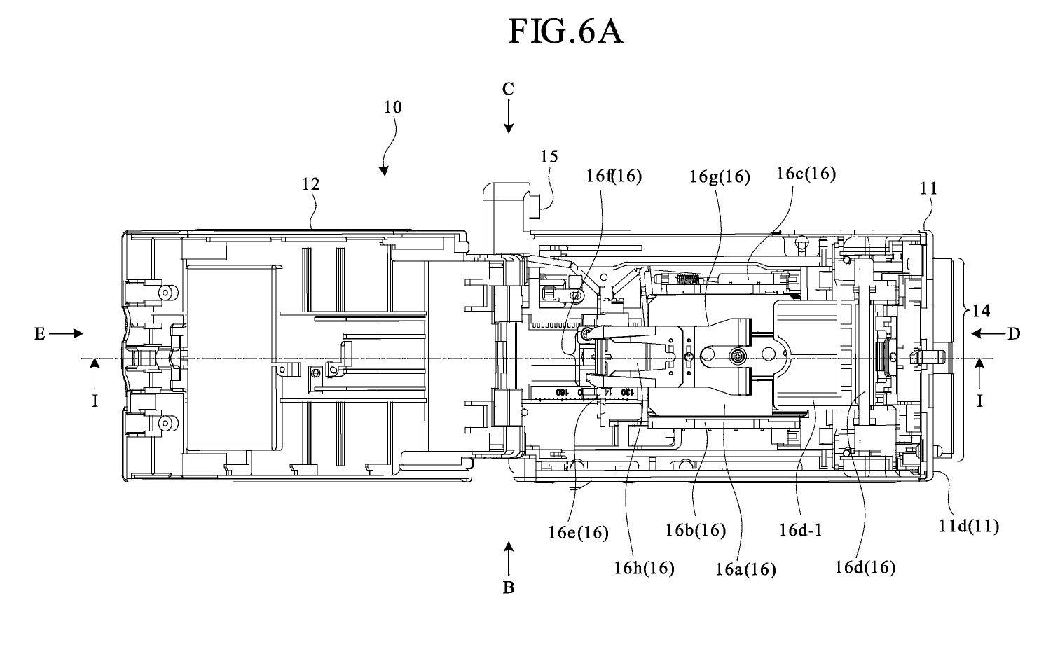

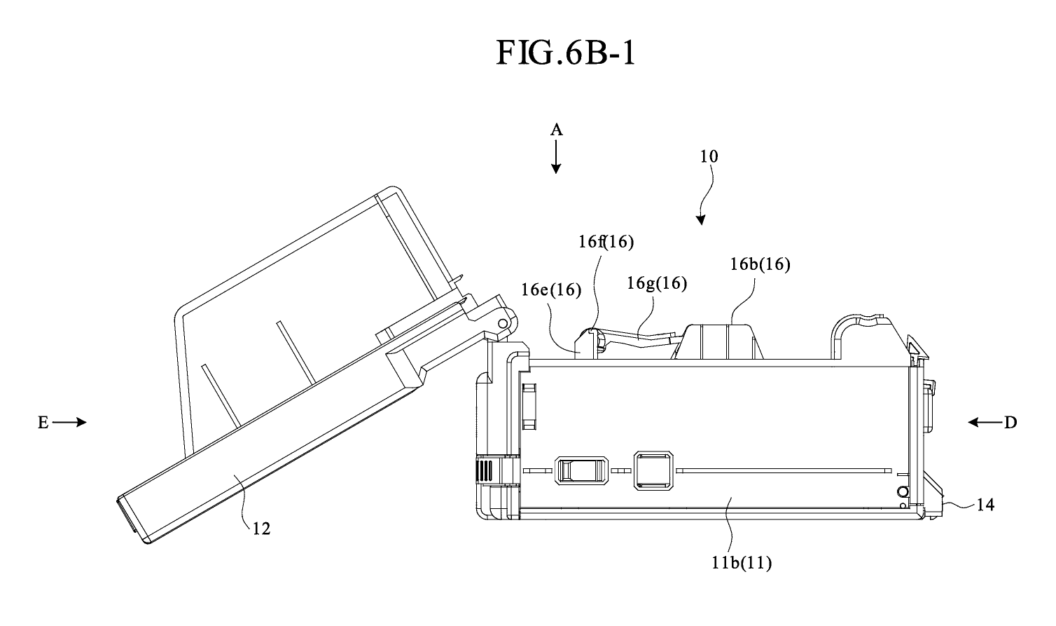

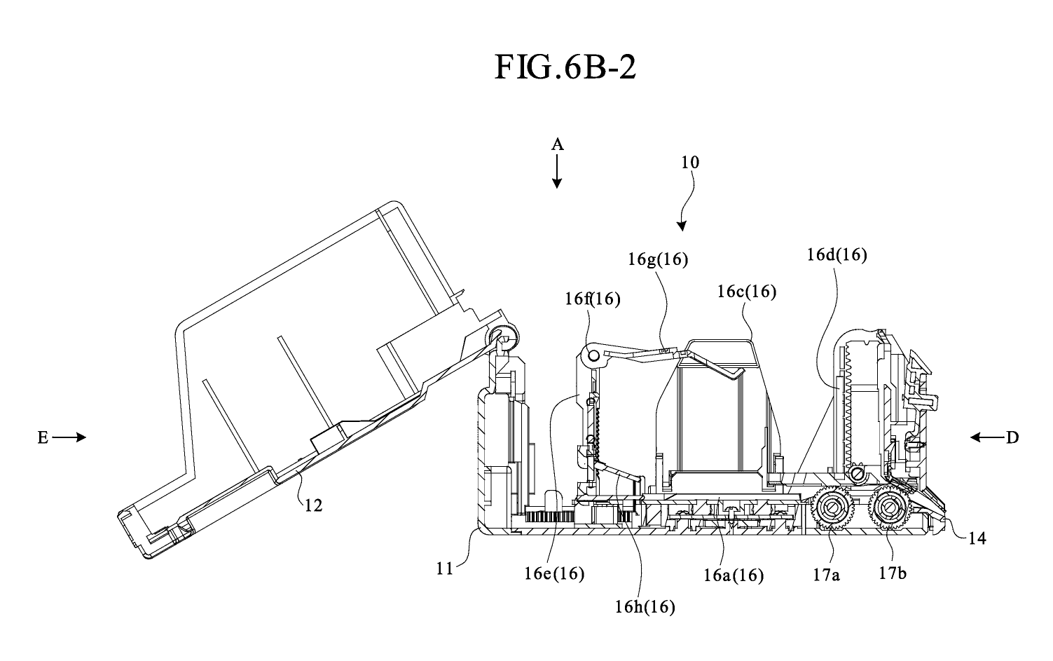

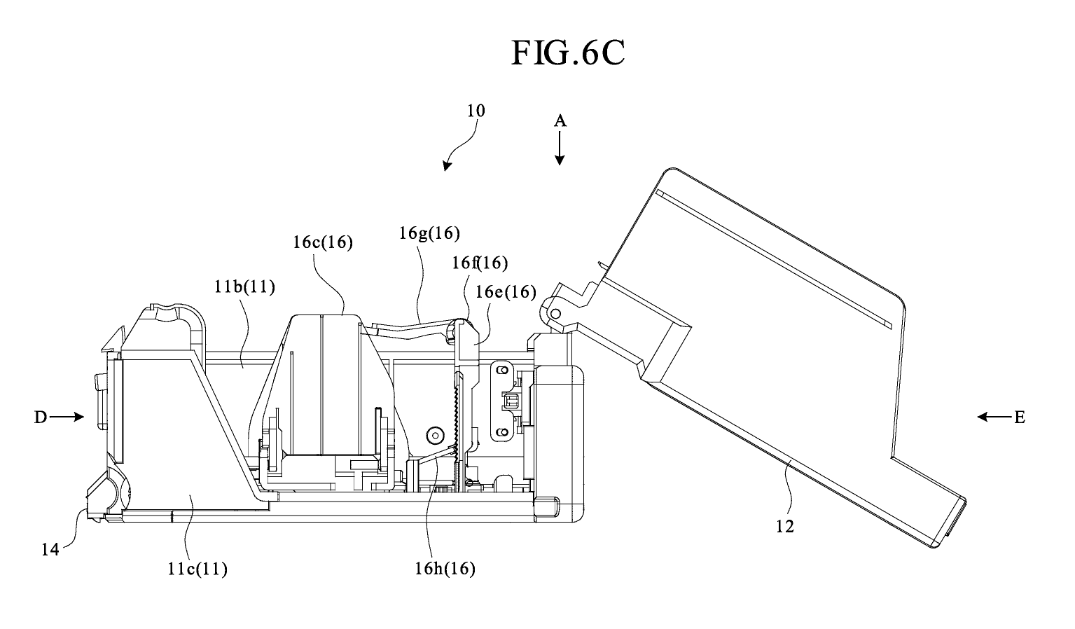

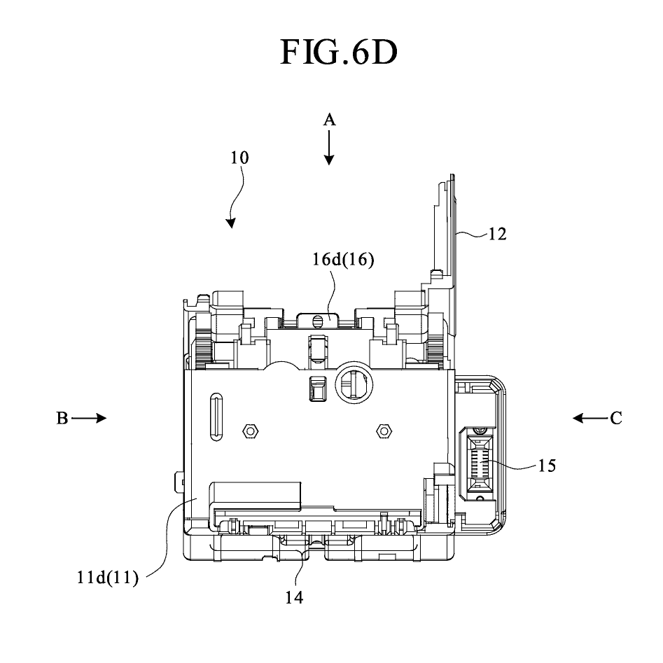

FIG. 6A is a flat view of the bill storage device (with the cover unit opened) according to the embodiment when viewed from A direction of FIG. 5A. As illustrated in FIG. 6A, a bill front-end pressing unit 16d-1 having a plane surface parallel or substantially parallel with the bottom surface portion 16a is provided to the upper end of the upstanding portion 16d. The bill front-end pressing unit 16d-1 presses the front end area on the side of D direction of a bill set in the bill accommodation space of the bill accommodation unit 16.

FIG. 6B-1 is a side view of the bill storage device (with the cover unit opened) according to the embodiment when viewed from B direction of FIG. 5A. FIG. 6B-2 is a sectional view of the bill storage device according to the embodiment along I-I line of FIG. 6A. FIG. 6C is a side view of the bill storage device according to the embodiment when viewed from C direction of FIG. 5A. FIG. 6D is a front view of the bill storage device according to the embodiment when viewed from D direction of FIG. 5A.

As seen in FIG. 6B-2 with reference to FIGS. 5A to 6B-1, FIG. 6C, and FIG. 6D, the bill storage device 10 includes a pick roller 17a and a separation roller 17b between the bottom surface portion 16a of the bill accommodation unit 16 and the bill ejection port 14. The pick roller 17a and the separation roller 17b have rotary surfaces having friction coefficients large enough to feed the bills by rotating the bills in contact with the bills. The pick roller 17a and the separation roller 17b constitute the same driving system using a driving transmission belt (not illustrated) and are rotated in the same direction by the driving force transmitted from a driving device (not illustrated).

In the bill storage device 10, the front end area in the longitudinal direction of a bill positioned in the lowermost layer of the bills set in the bill accommodation space of the bill accommodation unit 16 contacts the pick roller 17a. The bill is slid by means of rotation of the pick roller 17a using friction between the bill and the pick roller 17a. In the bill storage device 10, the bill slid by the pick roller 17a contacts the separation roller 17b and is ejected outside the bill storage device 10 from the bill ejection port 14 by means of rotation of the separation roller 17b using friction between the bill and the separation roller 17b.

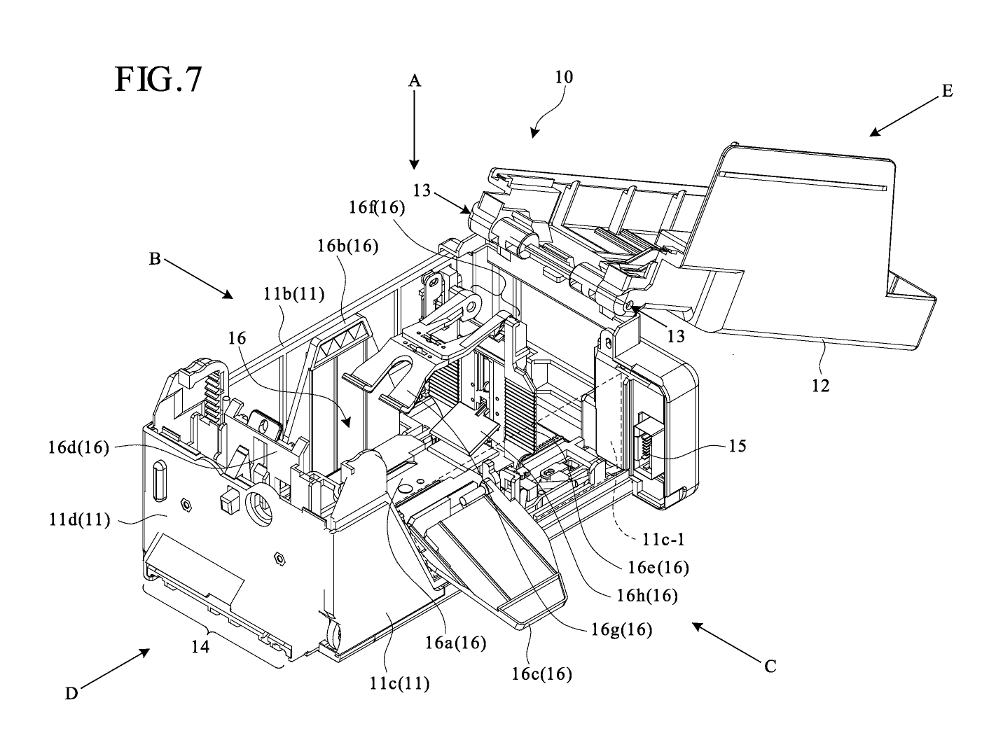

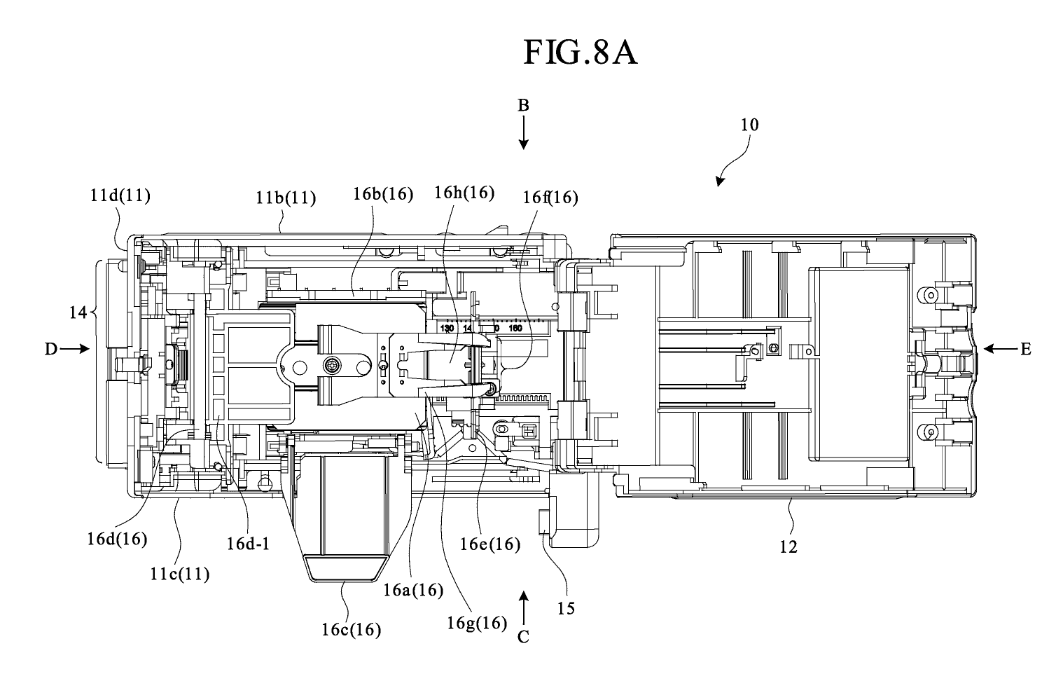

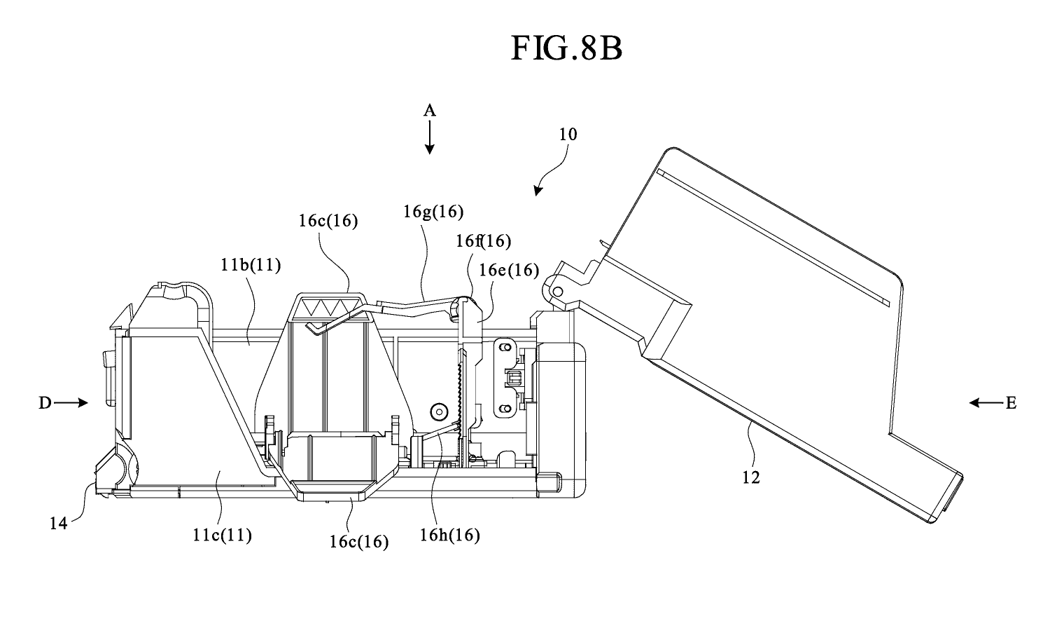

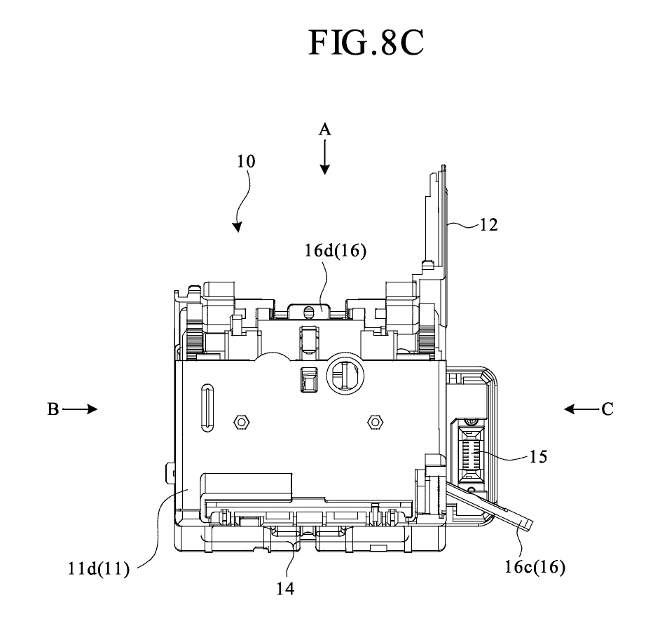

FIG. 7 is a perspective view of the bill storage device (with the cover unit opened and with an upstanding portion of the bill accommodation unit inclined) according to the embodiment. FIG. 7 illustrates the bill accommodation unit 16 in FIG. 5B with the upstanding portion 16c inclined. FIG. 8A is a flat view of the bill storage device (with the cover unit opened and with the upstanding portion of the bill accommodation unit inclined) according to the embodiment when viewed from A direction of FIG. 7. FIG. 8B is a side view of the bill storage device (with the cover unit opened and with the upstanding portion of the bill accommodation unit inclined) according to the embodiment when viewed from C direction of FIG. 7. FIG. 8C is a front view of the bill storage device (with the cover unit opened and with the upstanding portion of the bill accommodation unit inclined) according to the embodiment when viewed from D direction of FIG. 7.

As illustrated in FIGS. 7 to 8C, the upstanding portion 16c of the bill accommodation unit 16 can be inclined outward of the bill storage device 10 from the upstanding base provided in a manner upstanding on the bottom surface portion 16a of the bill accommodation unit 16 across the notch portion 11c-1 of the upstanding surface 11c. This configuration allows the bills to be set in the later-described bill accommodation space of the bill accommodation unit 16 laterally from C direction across the notch portion 11c-1 of the upstanding surface 11c and therefore facilitates setting of the bills.

Bill Feeding According to the Embodiment

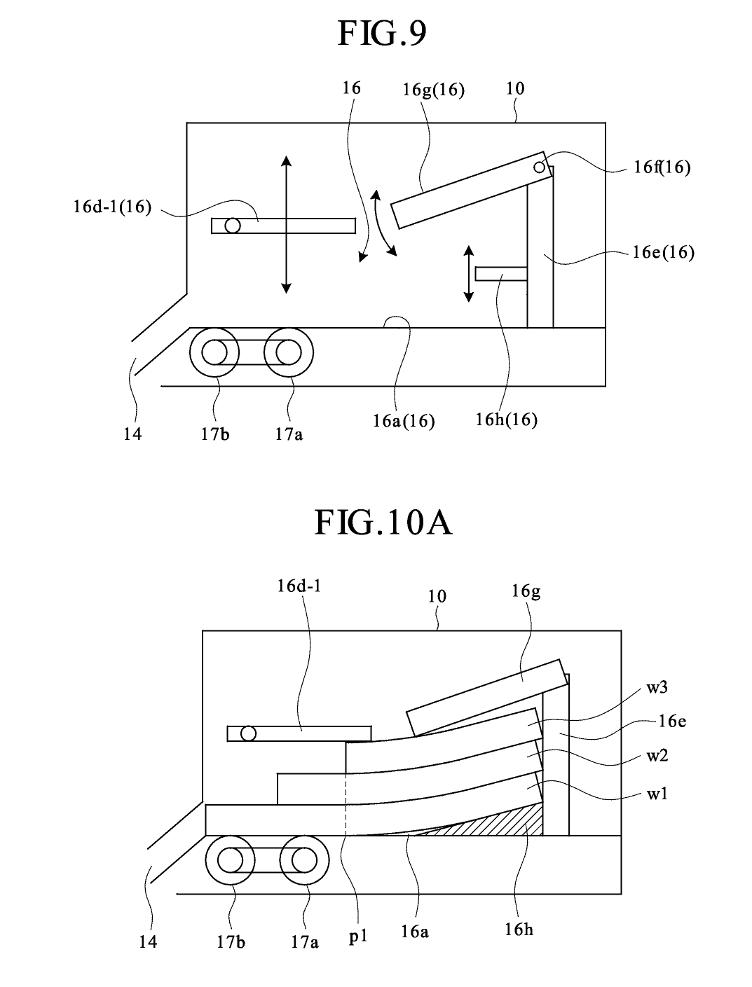

FIG. 9 is a schematic view of a general configuration of the bill storage device according to the embodiment. FIG. 9 illustrates a general configuration relating to bill feeding when viewed from C direction in the bill storage device 10 illustrated in FIG. 3 to FIG. 8C. As illustrated in FIG. 9, the bill storage device 10 has the bill accommodation unit 16 including the bottom surface portion 16a, the bill front-end pressing unit 16d-1, the upstanding portion 16e, the hinge unit 16f, the bill rear-end pressing unit 16g, and the bill rear-end lifting unit 16h as components relating to bill feeding. The bill storage device 10 further has the bill ejection port 14, the pick roller 17a, and the separation roller 17b as components relating to bill feeding. Other components will be omitted in describing bill feeding.

As illustrated in FIG. 9, the bill front-end pressing unit 16d-1 is vertically movable in the height direction with respect to the bottom surface portion 16a depending on the number of set bills. As illustrated in FIG. 9, the bill rear-end pressing unit 16g is half rotatable in both directions indicated by the arrow using the shaft of the hinge unit 16f as a rotation axis depending on the number of set bills.

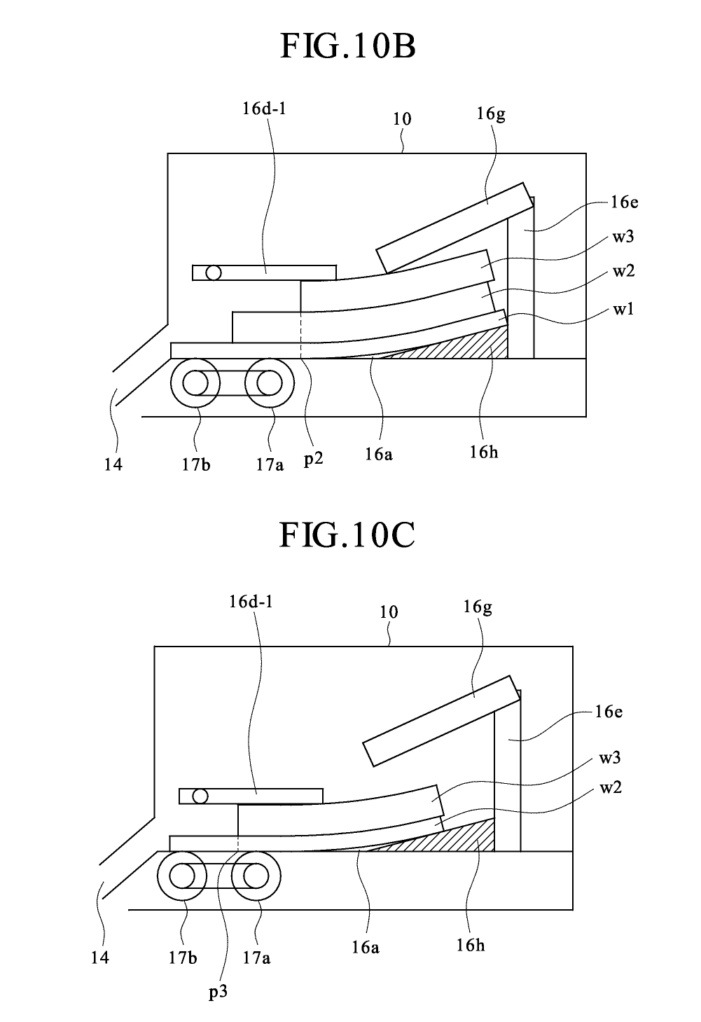

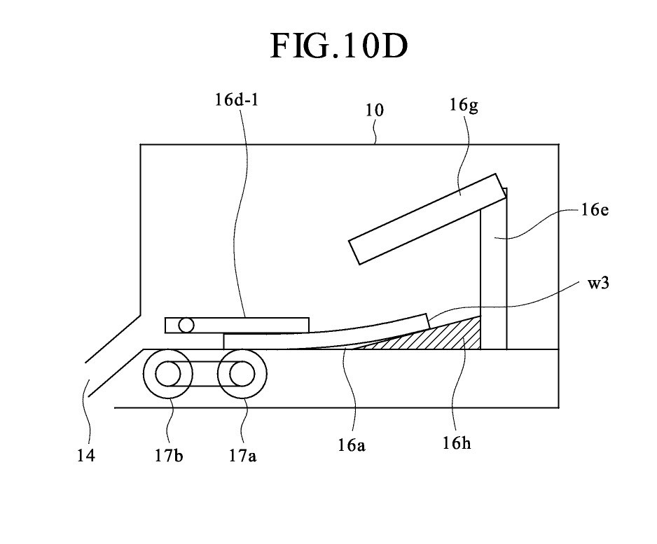

FIG. 10A to FIG. 10D illustrate schematic configurations relating to bill feeding in the bill storage device according to the embodiment. In FIG. 10A to FIG. 10D, the shape of the bill rear-end lifting unit 16h is simply illustrated.

In FIG. 10A, bill bundles w1 to w3 are set in the bill storage device 10 in a manner stacked in this order from the bottom on the bottom surface portion 16a. Each of the bill bundles w1 to w3 includes bills of the same size and the same denomination. In the example of FIG. 10A, the difference in size (for example, the size in the longitudinal direction) between the bills included in the bill bundles w1 to w3 is represented as bill bundle w1>bill bundle W2>bill bundle w3.

As illustrated in FIG. 10A, the bill bundle w3 in the uppermost layer is pressed from above by the bill front-end pressing unit 16d-1 and the bill rear-end pressing unit 16g. The bill bundles w1 to w3 have the respective rear ends in the longitudinal direction substantially aligned with respect to the upstanding portion 16e. Moreover, the bill bundles w1 to w3 have the respective rear ends in the longitudinal direction lifted from the bottom surface portion 16a by the bill rear-end lifting unit 16h. In other words, the bill bundles w1 to w3 have the respective rear ends in the longitudinal direction supported by the bill rear-end lifting unit 16h in the positions separated from the bottom surface portion 16a. In this state, the bill rear-end lifting unit 16h is pressed down so as to get closest to the bottom surface portion 16a side due to the weights of the bill bundles w1 to w3.

The pick roller 17a and the separation roller 17b sequentially feed the bills in the bill bundle w1, whereby the number of bills included in the bill bundle w1 is reduced as illustrated in FIG. 10B. With the bills in the bill bundle w1 sequentially fed, the level at which the bill front-end pressing unit 16d-1 presses the bill bundles w1 to w3 descends. With the bills in the bill bundle w1 sequentially fed and ejected from the bill ejection port 14, the bill bundles w1 to w3 gradually move to the bill ejection port 14 side due to the inclination of the bill rear-end lifting unit 16h.

As illustrated in FIG. 10C, when the pick roller 17a and the separation roller 17b finish feeding all the bills included in the bill bundle w1, the pick roller 17a and the separation roller 17b sequentially feed the bills included in the bill bundle w2, and the number of bills in the bill bundle w2 is accordingly decreased. With the bills in the bill bundle w2 sequentially fed, the level at which the bill front-end pressing unit 16d-1 presses the bill bundles w2 and w3 descends. With the bills in the bill bundle w2 sequentially fed and ejected from the bill ejection port 14, the bill bundles w2 and w3 gradually move to the bill ejection port 14 side due to the inclination of the bill rear-end lifting unit 16h.

In FIG. 10A and FIG. 10B, the foot of the perpendicular from the front end of the bill bundle w3 to the bottom surface portion 16a is positioned at p1 and p2, respectively, and neither position reaches the slidable point of the pick roller 17a. In FIG. 10C, however, moving of the bill bundle w3 to the bill ejection port 14 side allows the foot of the perpendicular from the front end of the bill bundle w3 to the bottom surface portion 16a to be positioned in p3 and to reach the slidable point of the pick roller 17a.

As illustrated in FIG. 10D, the front end of the bill bundle w3 is therefore positioned in the slidable point of the pick roller 17a when slid out by the pick roller 17a. With this configuration, the bills included in the bill bundle w3 are fed by the pick roller 17a and the separation roller 17b and ejected from the bill ejection port 14.

The bills set in the bill storage device 10 may be stacked on a per bill bundle basis and set in the bill storage device 10 or may be stacked on a per bill basis and set in the bill storage device 10.

Example of Lifting Rear End of Bill

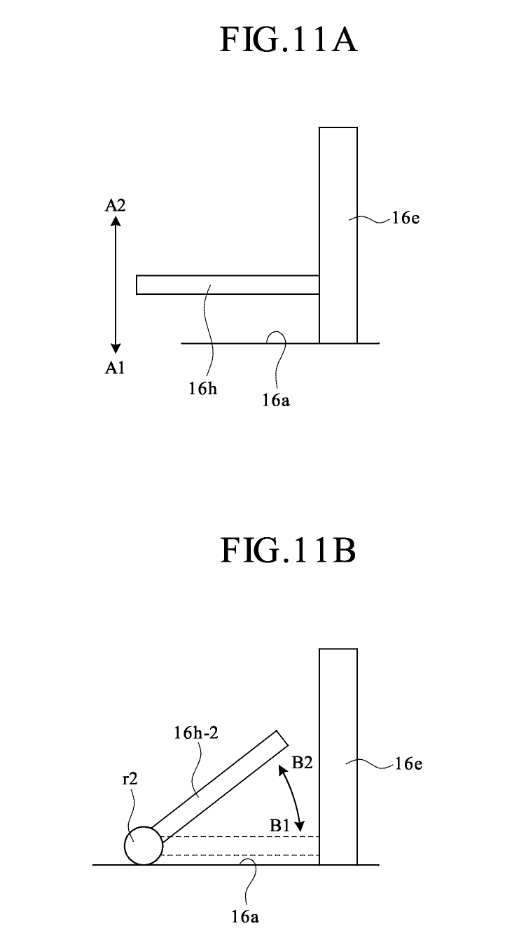

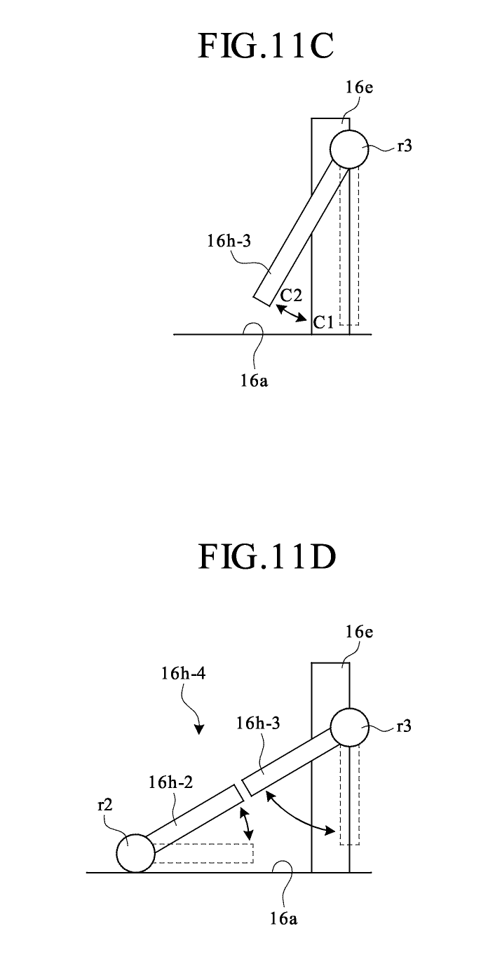

FIG. 11A is a schematic view of a first form of a bill rear-end lifting unit of the bill storage device according to the embodiment. The first form of the bill rear-end lifting unit is implemented as the above-described bill rear-end lifting unit 16h. The bill rear-end lifting unit 16h includes an elastic body (not illustrated) and moves to the directions indicated by the arrow of FIG. 11A depending on the number of bills, which is implemented as, for example, a stage. If the number of bills is large and accordingly the bills have a large weight, the bill rear-end lifting unit 16h moves to A1 direction illustrated in FIG. 11A due to compression of the elastic body caused by the own weight and the weight of the bills. When the weight is decreased with a decrease in the number of bills, the bill rear-end lifting unit 16h moves to A2 direction illustrated in FIG. 11A by means of the elasticity of the elastic body.

By being pressed by means of elastic deformation of the elastic body caused by the own weight and the weight of the bills, the bill rear-end lifting unit 16h supports the rear end area of the bill or the bill bundle in a manner separating from the bottom surface portion 16a. In this manner, the bill rear-end lifting unit 16h lifts the rear end of a bill or a bill bundle in the longitudinal direction from the bottom surface portion 16a. The bill rear-end lifting unit 16h lifts the stacked bills from the lowermost layer, which can move the bills to the pick roller 17a and the separation roller 17b side from a bill in the lower layer.

FIG. 11B is a schematic view of a second form of the bill rear-end lifting unit of the bill storage device according to the embodiment. Instead of the above-described bill rear-end lifting unit 16h, the second form of the bill rear-end lifting unit is implemented as a bill rear-end lifting unit 16h-2. The bill rear-end lifting unit 16h-2 includes an elastic body (not illustrated) and half rotates in the direction of the arrow in FIG. 11B using a shaft r2 as a rotation axis and lifts the rear end of a bill or a bill bundle in the longitudinal direction from the bottom surface portion 16a, which is implemented as, for example, a flap. The bill rear-end lifting unit 16h-2 moves to the directions of the arrow in FIG. 11B depending on the number of bills.

If the number of bills is large and accordingly the bills have a large weight, the bill rear-end lifting unit 16h-2 moves to B1 direction illustrated in FIG. 11B due to compression of the elastic body caused by the own weight and the weight of the bills. When the weight is decreased with a decrease in the number of bills, the bill rear-end lifting unit 16h-2 moves to B2 direction in FIG. 11B by means of the elasticity of the elastic body. By being pressed by means of elastic deformation of the elastic body caused by the own weight and the weight of the bills, the bill rear-end lifting unit 16h-2 supports the rear end area of the bill or the bill bundle in a manner separating from the bottom surface portion 16a.

In FIG. 11B, the shaft r2 is provided in a position farthest from the upstanding portion 16e on the bill rear-end lifting unit 16h-2; however, the position is not limited thereto, and the shaft r2 may be provided in a position closest to the upstanding portion 16e on the bill rear-end lifting unit 16h-2.

FIG. 11C is a schematic view of a third form of the bill rear-end lifting unit of the bill storage device according to the embodiment. Instead of the above-described bill rear-end lifting unit 16h, the third form of the bill rear-end lifting unit is implemented as a bill rear-end lifting unit 16h-3. The bill rear-end lifting unit 16h-3 includes an elastic body (not illustrated) and half rotates in the directions of the arrow in FIG. 11C using a shaft r3 as a rotation axis and lifts the rear end of a bill or a bill bundle in the longitudinal direction from the bottom surface portion 16a, which is implemented as, for example, a flap. The bill rear-end lifting unit 16h-3 moves to the directions of the arrow in FIG. 11C depending on the number of bills.

If the number of bills is large and accordingly the bills have a large weight, the bill rear-end lifting unit 16h-3 moves to C1 direction in FIG. 11C due to, for example, compression of the elastic body caused by the own weight and the weight of the bills. When the weight is decreased with a decrease in the number of bills, the bill rear-end lifting unit 16h-3 moves to C2 direction in FIG. 11C by means of the elasticity of the elastic body. By being pressed by means of elastic deformation of the elastic body caused by the own weight and the weight of the bills, the bill rear-end lifting unit 16h-3 supports the rear end area of the bill or the bill bundle in a manner separating from the bottom surface portion 16a.

FIG. 11D is a schematic view of a fourth form of the bill rear-end lifting unit of the bill storage device according to the embodiment. Instead of the above-described bill rear-end lifting unit 16h, the fourth form of the bill rear-end lifting unit is implemented as a bill rear-end lifting unit 16h-4. The bill rear-end lifting unit 16h-4 is configured as a combination of the above-described bill rear-end lifting unit 16h-2 and the bill rear-end lifting unit 16h-3 and lifts the rear end of a bill or a bill bundle in the longitudinal direction from the bottom surface portion 16a. By being pressed by means of elastic deformation of the elastic body caused by the own weight and the weight of the bills, the bill rear-end lifting unit 16h-4 supports the rear-end area of the bill or the bill bundle in a manner separating from the bottom surface portion 16a.

The elastic body pressing the above-described bill rear-end lifting units 16h to 16h-4 by being elastically deformed may be provided in any position as long as the function is achieved. For example, a spring may be provided between the bill rear-end lifting unit 16h and the bottom surface portion 16a, between the bill rear-end lifting unit 16h-2 and the bottom surface portion 16a, and between the bill rear-end lifting unit 16h-3 and the upstanding portion 16e. In another case, for example, a spring may be provided to the shaft r2 and the shaft r3. The elastic body and its position are not limited to these examples.

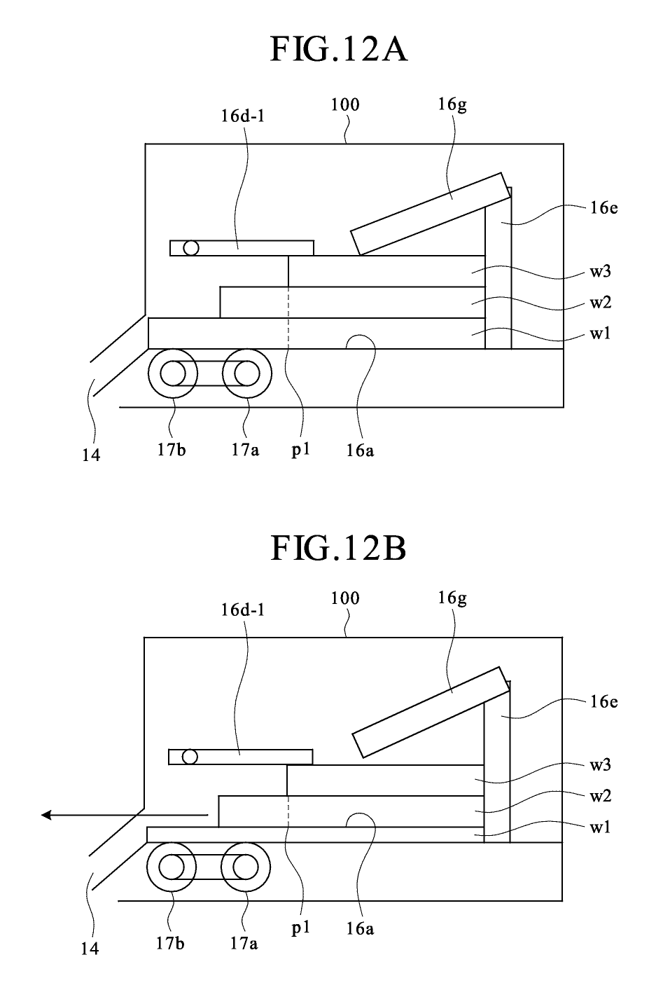

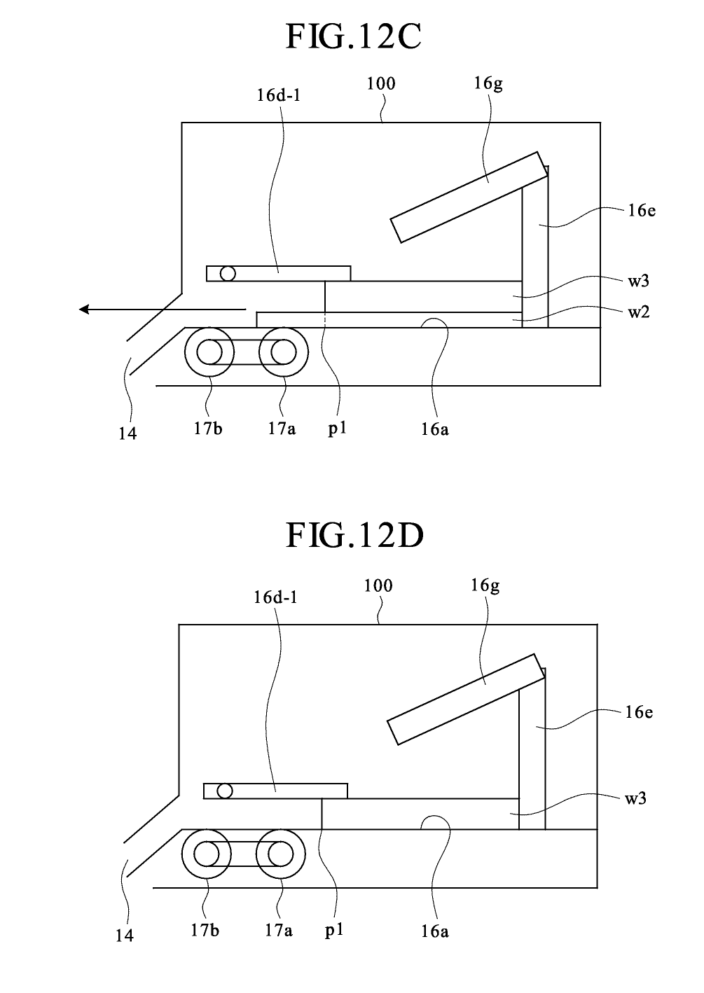

In bill feeding of a bill storage device 100 according to a conventional technique illustrated in FIG. 12A to FIG. 12D, of the bill bundles w1 to w3, bills included in the bill bundles w1 and w2 are sequentially fed by the pick roller 17a and the separation roller 17b and ejected from the bill ejection port 14. In this case, as illustrated in FIG. 12A to FIG. 12D, in the bill storage device 100, the foot of the perpendicular from the front end of the bill bundle w3 to the bottom surface portion 16a remains positioned in p1. As illustrated in FIG. 12D, in an attempt to slide out the bills included in the bill bundle w3, the bills are unable to be slid because the bills does not reach the slidable point of the pick roller 17a.

As seen from comparison between FIG. 10A to FIG. 10D and FIG. 12A to FIG. 12D, use of any of bill rear-end lifting units 16h to 16h-4 in the embodiment exerts the following advantageous effects. When picking up a relatively small size bill of bills of different sizes and different denominations stored in the bill storage device 10, the inconvenience that the small size bill is not caught by the pick roller 17a can be avoided. If a relatively large size bill is placed on a relatively small size bill, the large size bill is problematically slid together with the small size bill in a manner overlapped on the small size bill in picking up the small size bill with the pick roller 17a, and the difference in size causes the large size bill to reach the separation roller 17b earlier. This kind of inconvenience can be avoided. In the above-described embodiment, these factors and others of the bill handling apparatus 1 including the bill storage device 10 result in smooth and stable sliding or feeding of bills at certain intervals in sliding or feeding the bills, which can reduce bill jams.

When the number of bills is large and accordingly the bills have a large weight, the bill rear-end lifting units 16h to 16h-4 move to directions in which the bill rear-end lifting units 16h to 16h-4 are pressed down due to compression of the elastic body caused by the own weight and the weight of the bills. With this configuration, a larger number of bills can be accommodated. On the other hand, when the number of bills is small and accordingly the bills have a small weight, the bill rear-end lifting units 16h to 16h-4 move to directions in which the bill rear-end lifting units 16h to 16h-4 are pressed up due to elasticity of the elastic body. This configuration allows more accurate sliding or feeding of bills. Even when the bill storage device 10 accommodates bills of the same size and the same denomination, the same advantageous effects can be exerted.

The advantageous effects of stable sliding or feeding of bills at certain intervals can be exerted even when the pick roller 17a also functions as the separation roller 17b. In this case, the pick roller 17a picks up a bill and feeds the picked bill through the bill ejection port 14, and the same advantageous effects can be exerted with this configuration.

Overview of Bill Setting

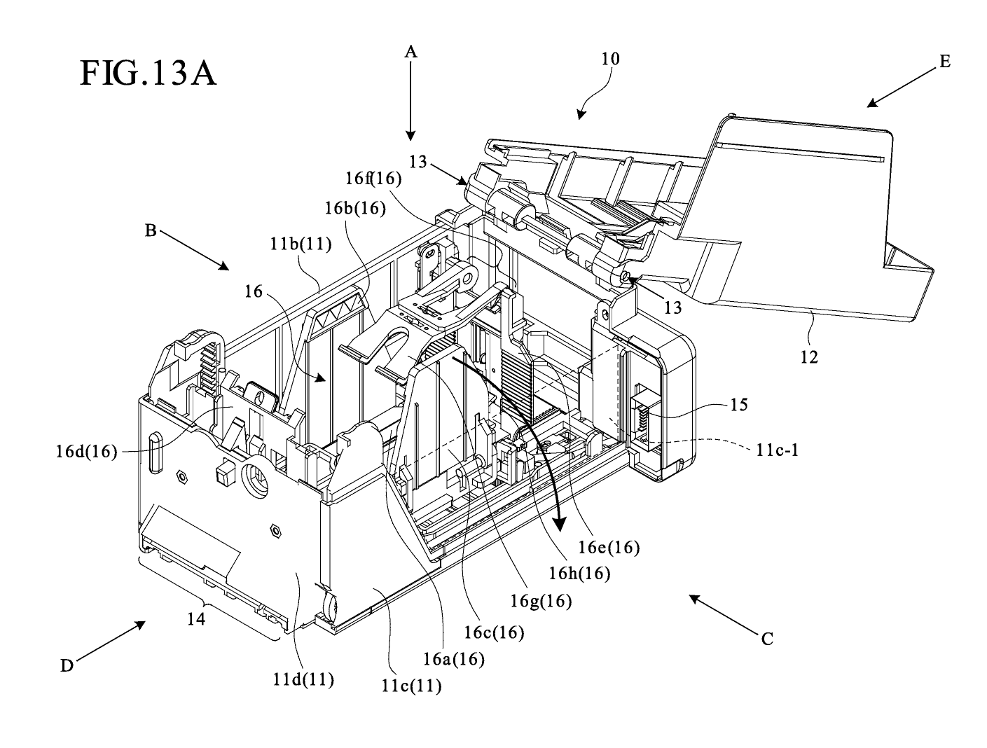

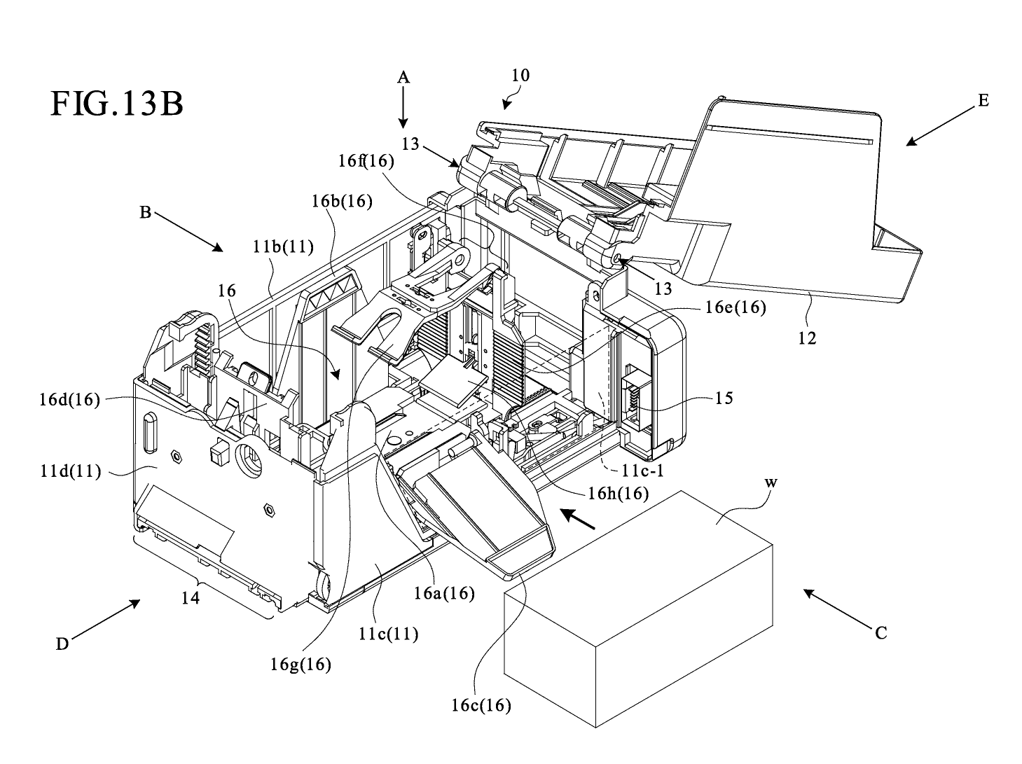

FIG. 13A and FIG. 13B illustrate schematic configurations relating to bill setting in the bill storage device according to the embodiment. As illustrated in FIG. 13A, in the bill storage device 10, the upstanding portion 16c of the bill accommodation unit 16 can be inclined in the direction of the arrow of FIG. 13A. As illustrated in FIG. 13B, the bill storage device 10 is able to have bills or a bill bundle w set from C direction of FIG. 13B with the upstanding portion 16c of the bill accommodation unit 16 inclined. When the bills or the bill bundle w has been set in the bill accommodation unit 16, the upstanding portion 16c is put back to the initial state, and the body unit 11 is closed by the cover unit 12.

As described earlier, the upstanding portion 16c of the bill accommodation unit 16 can be inclined outward of the bill storage device 10 from the upstanding base provided in a manner upstanding on the bottom surface portion 16a of the bill accommodation unit 16 across the notch portion 11c-1 of the upstanding surface 11c. With this configuration, when setting the bills or the bill bundle w in the bill accommodation space of the bill accommodation unit 16, the bills or the bill bundle w can be easily set laterally from C direction across the notch portion 11c-1 of the upstanding surface 11c. This configuration can reduce the work load to supply bills to the bill storage device 10. Easier setting of bills is advantageous in setting the bills aligned, which results in a reduction in jams caused when sliding out the bills.

Following notes are disclosed in relation to the embodiment including the above-described examples.

Note 1

A sheet storage device comprising:

a body unit that has a notch portion;

a cover unit that closes the body unit; and

an accommodation unit that accommodates a sheet in an accommodation area formed with an upstanding surface provided in a manner upstanding on a certain surface, wherein

when the body unit is opened, a certain upstanding surface provided in an upstanding manner in a position closest to the notch portion of upstanding surfaces can be inclined outward of the body unit across the notch portion, and

the accommodation unit can accommodate the sheet in the accommodation area through the notch portion with the certain upstanding surface inclined.

Note 2

The sheet storage device according to note 1, wherein the cover unit has a covering portion that covers the notch portion when closing the body unit.

The structure of each unit described in the examples can be changed or omitted without departing from the technical thoughts of a bill storage device and a bill handling apparatus according to the disclosed techniques. The embodiments are given as illustrative examples only, and other forms made by changing and modifying the technical thoughts in various manners based on the knowledge of the skilled person are included in the disclosed techniques.

With exemplary disclosed techniques, a sheet storage device and a sheet handling apparatus capable of reducing paper jams are provided.

All examples and conditional language provided herein are intended for the pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A sheet storage device comprising:
an accommodation unit that accommodates a sheet in a manner stacking on a certain surface;
a sheet sliding unit that is positioned on a first end side of a sheet accommodated in the accommodation unit and sequentially slides a sheet from a sheet positioned in a lowermost layer; and
a supporting unit that is positioned on a second end side opposite to the first end side of a sheet accommodated in the accommodation unit and supports an area around the second end of the sheet in a manner separating from the certain surface by being pressed by a weight of the sheet and an own weight.

2. The sheet storage unit according to claim 1, wherein the supporting unit is a stage parallel with the certain surface.

3. The sheet storage unit according to claim 1, wherein the supporting unit is a flap provided on the certain surface.

4. The sheet storage unit according to claim 1, wherein the supporting unit is a flap provided on a surface perpendicular to the certain surface.

5. The sheet storage unit according to claim 1, wherein the supporting unit includes a first flap provided on the certain surface and a second flap provided on a surface perpendicular to the certain surface.

6. A sheet handling apparatus comprising:
a housing;
a retaining unit; and
a sheet storage device retained in the retaining unit, wherein
the sheet storage device includes:
an accommodation unit that accommodates a sheet in a manner stacking on a certain surface;
a sheet sliding unit that is positioned on a first end side of a sheet accommodated in the accommodation unit and sequentially slides a sheet from a sheet positioned in a lowermost layer into the housing; and
a supporting unit that is positioned on a second end side opposite to the first end side of a sheet accommodated in the accommodation unit and supports an area around the second end of the sheet in a manner separating from the certain surface by being pressed by a weight of the sheet and an own weight.
